(19) United States
(12) Patent Application Publication
(10) Pub. No.: US 2010/0152405 A1
(43) Pub. Date: Jun. 17, 2010

(54) THERMOPLASTIC POLYURETHANES COMPRISING POLYTRIMETHYLENE ETHER SOFT SEGMENTS

(75) Inventor: Hari Babu SUNKARA, Hockessin, DE (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E.I. DU PONT DE NEMOURS AND COMPANY, Wilmington, DE (US)

(21) Appl. No.: 12/708,795

(22) Filed: Feb. 19, 2010

Related U.S. Application Data
(63) Continuation-in-part of application No. 11/294,850, filed on Dec. 6, 2005.

(51) Int. Cl. C08G 18/10; C08G 18/06; D01F 6/70

(52) U.S. Cl. 528/65

(57) ABSTRACT

Provided are hermoplastic polyurethanes prepared from reactants comprising: (a) polytrimethylene ether glycol; (b) diisocyanate; (c) diol chain extender; and (d) monofunctional isocyanate reactive alcohol or amine. Also provided are methods of manufacturing the polyurethanes.

### FIELD OF THE INVENTION

This invention relates to thermoplastic polytrimethylene ether urethane compositions, processes for their manufacture and shaped articles comprising the thermoplastic polytrimethylene ether urethane compositions.

### BACKGROUND

Polyurethane polymers belong to the family of thermoplastic elastomers (TPE's) and are typically block copolymers comprising blocks of soft and hard segments. The soft segments are formed primarily from polyether or polyester polyol, and the hard segments are formed primarily from diisocyanate and chain extenders (the hydroxyl at the ends of the polyether glycols being considered to form part of the hard segment). Polyurethane elastomers are widely used to make spandex fibers, films, foams, resins, adhesives and coatings for various end uses, including automotive bumper covers, solid tires, industrial rollers, shoe soles and sport boots, as well as for biomedical and other applications.

Spandex fibers are segmented polyurethane-urea copolymers consisting of alternating polyurethane-urea hard segments and polyether or polyester soft segments. Both the polymerization process to make polymer and the dry spinning process to produce spandex fibers are carried out in the presence of a solvent, e.g. dimethyl formamide or dimethyl acetamide. In the dry spinning process a highly viscous solution is put through a spinneret and simultaneously, hot air is supplied to evaporate the solvent. Therefore, the dry spinning process is an expensive, complicated and environmentally unfriendly process. Furthermore, most of the ingredients used to make commercial polyurethane polymers and spandex fibers are derived from fossil fuels and are non-renewable.

Preparing shaped articles from polyurethanes using a melt processing technique has long been desired. Such processes have been developed (see, e.g., “Chemical Fibers International”, Vol. 51, pages 46-48), but industry desires better properties and products from renewable resources.

Polyurethanes prepared using polytrimethylene ether glycol (PO3G) soft segment are disclosed in U.S. Pat. Nos. 6,852,823 and 6,946,539. PO3G can be prepared from 1,3-propanediol, which in turn can be prepared from renewable resources, such as corn and other crops. These polyurethanes can be used to make melt processed articles. The disclosed polyurethanes can be melt-processed to make fibers, films, and other products. There is still a desire for polyurethanes that can be more easily extruded.

### SUMMARY OF THE INVENTION

One aspect of the present invention is a thermoplastic polyurethane prepared from reactants comprising:

(a) polytrimethylene ether glycol;

(b) diisocyanate;

(c) diol chain extender; and

(d) monofunctional isocyanate reactive compound

wherein the polytrimethylene ether glycol, the diol chain extender and the monofunctional isocyanate reactive compound contain isocyanate reactive groups; such that the polyurethane contains isocyanate groups in a ratio of about 1.01:1 to about 1.05:1 to the total isocyanate reactive groups contained in the polytrimethylene ether glycol, diol chain extenders and monofunctional isocyanate reactive compound.

Another aspect of the present invention is a thermoplastic polyurethane comprising:
(a) 80 to 20 weight % of the thermoplastic polyurethane, soft segment derived from polytrimethylene ether glycol;
(b) 20 to 80 weight % of the thermoplastic polyurethane, hard segment derived from diisocyanate and diol; and
(c) 1 to 5 mole %, with respect to the diol, of a, monofunctional isocyanate reactive compound, alcohol or amine processing aid;

wherein the diisocyanate contains isocyanate groups in a ratio to total hydroxyl and amine groups contained in the polytrimethylene ether glycol, diol chain extenders and monofunctional alcohol or amine of from about 1.01:1 to about 1.05:1.

A further aspect of the present invention is a process for producing a thermoplastic polyurethane comprising:

(a) reacting diisocyanate and polytrimethylene ether glycol to form diisocyanate-terminated polytrimethylene ether-urethane prepolymer at a temperature in the range from 50 to 100° C.;

(b) reacting the diisocyanate-terminated polytrimethylene ether-urethane prepolymer with diol chain extender and monofunctional alcohol or amine, to form a reaction mixture; and

(c) post curing the reaction mixture at 110° C. for 16 hours;

such that the polyurethane contains isocyanate groups in a ratio to total hydroxyl and amine groups contained in the polytrimethylene ether glycol, diol chain extenders and monofunctional alcohol or amine of about 1.01:1 to about 1.05:1.

### DETAILED DESCRIPTION

The present invention provides thermoplastic polyurethane compositions that, in preferred embodiments, can be derived from bio-based ingredients that are environmentally friendly and suitable to produce shaped articles, such as thermoplastic elastic fibers and films, in a solvent-free, environmentally friendly process.

In the thermoplastic polyurethanes, the soft segment forms primarily from the polytrimethylene ether glycol and the hard segment forms primarily from the polyisocyanate and the diol chain extenders (the hydroxyl at the ends of the polytrimethylene ether glycols are considered to form part of the hard segment).

In one embodiment, there is provided a thermoplastic polyurethane comprising: (a) 80 to 20 weight %, by weight of the thermoplastic polyurethane, soft segment containing repeat units from polytrimethylene ether glycol; (b) 20 to 80 weight %, by weight of the thermoplastic polyurethane, hard segment comprising repeating units from diisocyanate and from diol chain extender; and (c) 1 to 5 mole %, with respect to the diol chain extender, monofunctional alcohol or monofunctional amine. The ratio of isocyanate groups in the diisocyanate to total hydroxyl and amine groups contained in the polytrimethylene ether glycol, diol chain extenders and monofunctional alcohol or amine is from about 1.01:1.0 to about 1.05:1.0. In one preferred embodiment, the thermoplastic polyurethane comprises 80 to 60 weight % soft segment and 20 to 40 weight %, hard segment. In another preferred embodiment, the thermoplastic polyurethane comprises 70 to 40 weight % soft segment and 30 to 60 weight %, hard segment.

The polytrimethylene ether glycols used in the processes and compositions disclosed herein can be prepared by the acid-catalyzed polycondensation of 1,3-propanediol reactant, such as described in U.S. Pat. Nos. 6,977,291, 7,323,539, 6,720,459, 7,074,969, 7,157,607, and 7,161,045. By “1,3-propanediol reactant” is meant 1,3-propanediol, its dimers and trimers, and mixtures thereof. The 1,3-propanediol employed for preparing the polytrimethylene ether glycols can be obtained by any of the various chemical routes or by biochemical transformation routes. Various routes are disclosed in U.S. Pat. Nos. 5,015,789, 5,276,201, 5,284,979, 5,334,778, 5,364,984, 5,364,987, 5,633,362, 5,686,276, 5,821,092, 5,962,745, 6,140,543, 6,232,511, 6235,948, 6,277,289, 6,297,408, 6,331,264 and 6,342,646, U.S. Pat. Nos. 5,633,362, 5,686,276, 5,821,092, 7,084,311, 7,098,368, 7,009,082, and U.S. Patent Application Publication No. 2005/0069997 A1. A highly preferred 1,3-propanediol is prepared by a fermentation process using a renewable biological source. Preferably the 1,3-propanediol used as the reactant or as a component of the reactant will have a purity of greater than about 99% by weight as determined by gas chromatographic analysis.

The molecular weight distribution or polydispersity index (M_{w}/Mₙ) of the polytrimethylene ether glycol produced from self-condensation of 1,3-propanediol follows Flory's distribution with 1,3-propanediol as a natural part of the distribution. The amount of unreacted 1,3-propanediol in the polymer and the molecular weight distribution of the polytrimethylene ether glycol depend on the molecular weight of the polytrimethylene ether glycol. The amount of unreacted 1,3-propanediol decreases with increase in molecular weight whereas the polydispersity index (Mw/Mn) increases with increase in molecular weight and can reach 2.0 or higher. Preferably the polydispersity index is less than 2.0. However, purification process conditions can further influence the amount of 1,3-propanediol and the molecular weight distribution in the polytrimethylene ether glycol. The polymer in general will have a lower amount of 1,3-propanediol and narrower molecular weight distribution than the polymer before the purification. The monomeric diol present in the polytrimethylene ether glycols can act as a chain extender and can react with isocyanate to form urethane hard segments. In the case of polyurethane prepared from polytrimethylene ether glycol and a diol other than 1,3-propanediol, the resulting polymer will contain a mixture of hard segments, which can impact the crystallinity of the hard segment and thereby affect the mechanical properties of the polyurethane. Surprisingly, the presence of small amounts of 1,3-propanediol in the polytrimethylene ether glycol has little effect on melt processibility and properties of the TPU polymer, as illustrated herein in Example 5. Preferably the polytrimethylene ether glycol has a monomeric 1,3-propanediol content less than 5.0 mol %.

Preferably, the polytrimethylene ether glycols after purification are substantially free of acid end groups, but they do contain unsaturated end groups, predominately allyl end groups, in the range of about 0.003 to about 0.03 meq/g. Thus, the polytrimethylene ether glycols can be considered to consist essentially of the compounds having the following formulae:

HO—((CH₂)₃O)ₘ—H (I)

HO—((CH₂)₃—O)ₘCH₂CH═CH₂ (II)

wherein m is in a range such that the Mₙ is within the aforementioned Mₙ range with compounds of formula (II) being present in an amount such that the allyl end groups (preferably all unsaturation ends or end groups) are present in the range of about 0.003 to about 0.03 meq/g.

The polytrimethylene ether glycol preferably has repeating units of which about 50 to 100 mole percent, more preferably from about 75 to 100 mole percent, even more preferably from about 90 to 100 mole percent, and most preferably from about 99 to 100 mole percent of the repeating units are trimethylene ether units.

Polytrimethylene polyether glycols are preferably prepared by polycondensation of monomers comprising 1,3-propanediol, thus resulting in polymers or copolymers containing trimethylene ether repeating units. As indicated above, at least 50% of the repeating units are preferably trimethylene ether units. Thus, minor amounts of other polyalkylene ether repeating units may be present also. Preferably these are derived from aliphatic diols other than 1,3-propanediol. Examples of typical aliphatic diols from which polyalkylene ether repeating units may be derived include those derived from aliphatic diols, for example ethylene glycol, 1,6-hexanediol, 1,7-heptanediol, 1,8-octanediol, 1,9-nonanediol, 1,10-decanediol, 1,12-dodecanediol, 3,3,4,4,5,5-hexafluoro-1,5-pentanediol-, 2,2,3,3,4,4,5,5-octafluoro-1,6-hexanediol, and 3,3,4,4,5,5,6,6,7,7,8,8,9,9,10,10-hexadecafluoro-1,12-dodecanediol, cycloaliphatic diols, for example 1, 4 cyclohexanediol, 1,4-cyclohexanedimethanol and isosorbide. A preferred group of aliphatic diols is selected from the group consisting of ethylene glycol, 2-methyl-1,3-propanediol, 2,2-dimethyl-1,3-propanediol, 2,2-diethyl-1,3-propanediol, 2-ethyl-2-(hydroxymethyl)-1,3-propanediol, 1,6-hexanediol, 1,8-octanediol, 1,10-decanediol, isosorbide, and mixtures thereof. The most preferred diol other than 1,3-propanediol is ethylene glycol.

The polytrimethylene ether glycols used in making the polyurethanes have a number average molecular weight (Mₙ) in the range of about 250 to about 5,000. Blends of polytrimethylene ether glycols can also be used in making polyurethanes. In one embodiment, the polytrimethylene ether glycol may be blended with other polymer diols selected from the group of polyether diols, polyester diols, polycarbonate diols, polyolefin diols and silicone diols. Mixtures of polymeric diol provide polyurethanes with very useful combinations of properties. In this embodiment, the polytrimethylene ether glycol is preferably blended with up to about 50 weight %, more preferably up to about 25 weight %, and most preferably up to about 10 weight %, of the other polymer diols.

Preferred polyether diols for blending with polytrimethylene ether glycol are polyethylene glycol, poly(1,2-propylene glycol), polytetramethylene glycol, copolyethers such as tetrahydrofuran/ethylene oxide and tetrahydrofuran/propylene oxide copolymers, and mixtures thereof.

Preferable polyester diols for blending with polytrimethylene ether glycol are hydroxyl terminated poly(butylene adipate), poly(butylene succinate) poly(ethylene adipate), poly(1,2-proylene adipate), poly(trimethylene adipate), poly(trimethylene succinate), poly(trimethylene sebacate), poly(trimethylene dodecanate), polylactic acid ester diol, and polycaprolactone diol. Other diols useful for blending include polycarbonate diols, polyolefin diols and silicone glycols. Preferable polycarbonate diols for blending with polytrimethylene ether glycol are selected from the group consisting of polyethylene carbonate diol, polytrimethylene carbonate diol, and polybutylene carbonate diol. Polyolefin diols are available from Shell as KRATON LIQUID L and Mitsubishi Chemical as POLYTAIL H. Silicone glycols are well known, and representative examples are described in U.S. Pat. No. 4,647,643.

Any diisocyanate useful in preparing polyurethanes from polyether glycols, diisocyanates and diols or amine can be used. They include, but are not limited to, 2,4-toluene diisocyanate, 2,6-toluene diisocyanate (“TDI”), 4,4′-diphenylmethane diisocyanater (“MDI”), 4,4′-dicyclohexylmethane diisocyanate (“H12MDI”), 3,3′-dimethyl-4,4′-biphenyl diisocyanate (“TODI”), 1,4-benzene diisocyanate, cyclohexane-1,4-diisocyanate, 1,5-naphthalene diisocyanate (“NDI”), 1,6-hexamethylene diisocyanate (“HDI”), 4,6-xylyene diisocyanate, isophorone diisocyanate (“IPDI”), and combinations thereof. MDI, HDI, and TDI are preferred.

Small amounts, preferably less than about 10 wt. % based on the weight of the diisocyante, of monoisocyanates or polyisocyanates can be used in mixture with the diisocyanate.

The function of a diol chain extender is to form a hard segment and to increase the molecular weight of the polyurethane polymers. Any diol chain extender useful in preparing polyurethanes can be used. The diols may be aromatic or aliphatic, linear or branched. Diol chain extenders useful in making the polyurethanes preferably have an average molecular weight in the range from 60 to about 600. They include, but are not restricted to ethylene glycol, 1,2-propylene glycol, 1,3-propanediol, 1,4-butanediol, 1,6-hexanediol, diethylene glycol, 2-methyl-1,3-propanediol, 3-methyl-1,5-pentanediol, 2,2-dimethyl-1,3-propanediol, 2,2,4-trimethyl-1,5-pentanediol, 2-methyl-2-ethyl-1,3-propanediol, 1,4-bis(hydroxyethoxy)benzene, bis(hydroxyethylene)terephthalate, hydroquinone bis(2-hydroxyethyl)ether, cyclohexane dimethanol, bis(2-hydroxyethyl) bisphenol A, and mixtures thereof. The diols also include glycol ethers such as diethylene glycol, triethylene glycol, dipropylene glycol, and tripropylene glycol. Preferred diol chain extenders are ethylene glycol, 1,3-propanediol, 1,4-butanediol, 1,6-hexanediol, and 2-methyl-1,3-propanediol.

The diol chain extender and the diisocyanate make up the hard segment of the polyurethane composition. Depending on the end use applications, the polyurethanes can have hard segments of from 20 to 80% by weight of the total weight of the polyurethane. The preferred thermoplastic polyurethane composition for fiber end use includes hard segments of 20 to 40% and the preferred composition for film end use includes hard segments of 30-60% by weight.

In order to control crystallization of the polyurethane, it may be advantageous to use a mixture of two or more, preferably two, diol chain extenders. In this case the chain extender mixture preferably will consist of 85 to 99% by weight, preferably 90 to 98% by weight and most preferably, 92 to 95% by weight of one diol, the primary diol, and of 1 to 15% by weight, preferably 2 to 10% by weight and most preferably, 5 to 8% by weight of another, or mixture of other, secondary diol. Preferred primary diols are ethylene glycol, 1,2-propylene glycol, 1,3-propanediol, 1,4-butanediol, 1,6-hexanediol, diethylene glycol, 2-methyl-1,3-propanediol, 3-methyl-1,5-pentanediol, 2,2-dimethyl-1,3-propanediol, 2,2,4-trimethyl-1,5-pentanediol, 2-methyl-2-ethyl-1,3-propanediol, 1,4-bis(hydroxyethoxy)benzene, bis(hydroxyethylene)terephthalate, hydroquinone bis(2-hydroxyethyl)ether, cyclohexane dimethanol, bis(2-hydroxyethyl) bisphenol A, diethylene glycol, triethylene glycol, dipropylene glycol, and tripropylene glycol. A more preferred primary diol is 1,4-butanediol. Preferred secondary diol chain extenders are ethylene glycol, 1,3-propanediol, 1,4-butanediol, 1,6-hexanediol, and 2-methyl-1,3-propanediol. A more preferred secondary diol is 1,3-propanediol.

Processing aids that can be used include monofunctional isocyanate reactive compounds such as alcohol or amine. The processing aids desirably aid in achieving improved extrudability and spinnability without affecting the molecular weight of the polyurethanes. The preferred processing aids are monoalcohols. Monoalcohols for use as processing aids are preferably C₂-C₁₈ alkyl alcohols such as n-butanol, n-hexanol, n-octanol, n-decanol, n-dodecanol, stearyl alcohol and C₂-C₁₂ fluorinated alcohols, and more preferably C₃-C₆alkyl alcohols such as n-propanol, n-butanol, and n-hexanol and mixtures thereof. Any monoamine reactive with isocyanates can also be used as processing aids. Preferred monoamines are the primary and secondary monoamines. Aliphatic primary or secondary monoamines are more preferred. Example of monoamines useful as processing aids include but are not restricted to ethylamine, propylamine, butylamine, hexylamine, octyl amine, 2-ethylhexylamine, dodecylamine, stearylamine, dibutylamine, dinonylamine, bis(2-ethylhexyl)amine, bis(methoxyethyl)amine, n-methylstearylamine and mixtures thereof.

Preferably the amount of monofunctional isocyanate reactive compound is from 0.5 to 5.0 mole percent with respect to the diol chain extender.

When monofunctional amines are used as processing aids, the resulting polymer has urea end groups. This contrasts with the formation of polyurethane-ureas which contain urea linkages throughout chain using a diamine. Thus, the processes disclosed herein are directed to preparing compositions that are called “polyurethanes”, not “polyurethane-ureas.”

In a preferred embodiment, the thermoplastic polyurethanes are prepared from one or more renewable ingredients. Examples of such bio-based ingredients include, but are not limited to, polytrimethylene ether glycols prepared from 1,3-propanediol, polytrimethylene ether ester diol, polytrimethylene succinate diol, polybutylene succinate diol and vegetable-based polyols such as soy polyols and castor polyols. Bio-based chain extenders include 1,3-propanediol, 1,4-butanediol, and ethylene glycol.

The polyurethanes can be prepared by one-step (one-shot) or multistep (multiple-shot) methods, preferably by multiple-shot methods. The properties of the polymer obtained from a one shot method are limited due random polymerization that occurs during process.

Batch, semi-continuous, and continuous reactors can be employed.

In one embodiment there is provided a one step process of producing thermoplastic polyurethane comprising: (a) providing (i) diisocyanate, (ii) polytrimethylene ether glycol, (iii) diol chain extender; and (iv) monofunctional alcohol or amine; and (b) reacting the diisocyanate, the polytrimethylene ether glycol, the diol chain extender and the monofunctional alcohol or amine. Preferably the ratio of isocyanate groups in the diisocyanate to total hydroxyl and amine groups contained in the polytrimethylene ether glycol, diol chain extenders and monofunctional alcohol or amine is about 1.01:1.0 to about 1.05:1.0. Preferably the reaction is performed in an extruder at a temperature of from about 100° C. to about 250° C.

In another embodiment there is provided a multistep process of producing thermoplastic polyurethane comprising: (a) reacting diisocyanate and polytrimethylene ether glycol while maintaining an NCO:OH equivalent ratio of about 1.1:1 to about 10:1 to form diisocyanate-terminated polytrimethylene ether-urethane prepolymer at a temperature in the range from 50 to 100° C.; and (b) reacting the diisocyanate-terminated polytrimethylene ether-urethane prepolymer with diol chain extender and monofunctional alcohol or amine at 60° C. first and then post cure at 110° C. for 16 hours. Preferably the ratio of isocyanate groups in the diisocyanate to total hydroxyl and amine groups contained in the polytrimethylene ether glycol, diol chain extenders and monofunctional alcohol or amine is about 1.01:1.0 to about 1.05:1.0.

The prepolymer of this multistep embodiment is stable and can be transported or moved to another location prior to reaction with a diol chain extender and a monofunctional alcohol or amine processing aid.

Alternatively, the reaction with diol chain extender and processing aid can be carried out immediately. According to a preferred process the prepolymer is heated to about 60-70° C., mixed thoroughly with a high-speed mixer with the diol(s) chain extender and the monofunctional compound. After mixing, the reaction is completed by heating at about 80° to about 100° C. Alternatively, the chain extender can be added first and then the monofunctional compound can be added at the end of the polymerization.

The polyurethanes can be made continuously by reaction in an extruder, preferably in a single or twin-screw extruder. Extruder reaction processes are known in the art and are described in U.S. Pat. Nos. 4,245,081 and 4,371,684. The reaction temperature in the extruder is generally in the range from about 100 to 250° C., preferably in reaction zones that increase in temperature so as to build MW, and the residence times of the reaction melt in the screw extruder are generally from about 0.5 to 30 minutes. Each of the ingredients can be fed separately, or one or more can be fed together. However, at least two feeds should be used, and in the event only two feed streams are used one stream should contain the (i) polytrimethylene ether glycol, (ii) diol chain extender, and (iii) monofunctional isocyanate reactive compound and the other stream should contain the diisocyanate. Both the one-shot and multiple-shot reactions described above are carried out in the extruder to make polyurethane prepolymers and final polymers.

The resulting polytrimethylene ether urethanes can be made into chips, flakes or pellets or processed directly either by melt or solution to make various shaped articles.

Catalysts are not necessary to prepare the polyurethanes, but may provide advantages in their manufacture. The catalysts most widely used are tertiary amines and organo-tin compounds such as stannous octoate, dibutyltin dioctoate, dibutyltin dilaurate, and they can be used either in the one-shot process, to make prepolymers, or in making polyurethanes from prepolymers as in the multistep process.

Additives can be incorporated into the polytrimethylene ether glycol, the prepolymer, or the polyurethane by known techniques. Useful additives include polyhydroxy functional branching agents (e.g., glycerin, trimethylolpropane, hexanetriol, pentaerythritol), mold release agents (e.g. silicones, fluoroplastics, fatty acid esters), delusterants (e.g., TiO₂, zinc sulfide or zinc oxide), minerals and nanocomposites for reinforcement (e.g. mica, organic fibers, glass fibers, etc.), colorants (e.g., dyes), stabilizers (e.g., antioxidants (e.g., hindered phenols and amines such as those sold under the trademarks IRGANOX, ETHANOX, LOWINOX), ultraviolet light stabilizers (e.g., TINUVIN 368, TINUVIN 765), plasticizers, heat stabilizers, etc., fillers, flame retardants, pigments, antimicrobial agents, antistatic agents, optical brightners, viscosity boosters, lubricating agents, antiblocking agents/extrusion processing aids (e.g. ACRAWAX C, GLYCOLUBE VL) and other functional additives.

The thermoplastic polyurethane compositions are processable by melt or solution casting, melt extrusion and/or calendering, injection molding and blow molding to form a variety of articles.

One embodiment is a shaped article comprising the thermoplastic polyurethane. Examples of shaped articles include fibers, films, sheets, hoses, tubing, wire and cable jackets, shoe soles, and air bag bladders. Shaped articles can also be used in or for medical devices. A further embodiment is a process of forming a shaped article comprising providing the thermoplastic polyurethane and melt processing the thermoplastic polyurethane to form the shaped article.

Another embodiment is a melt spun fiber comprising the thermoplastic polyurethane. The fiber can be a monofilament or multifilament fiber. The fiber can be in the form of a continuous filament or staple fiber. In some embodiments a woven or knit fabric can be made comprising the fiber. In a preferred embodiment of melt spinning the polyurethane from a spinneret to form a fiber the process further comprises the steps: (c) drawing the fiber and (d) winding the fiber on bobbins. In some embodiments, a woven or knit fabric comprising the fibers can be prepared by melt spinning, drawing and winding. The cross-section of the fiber of can be round or of any other suitable cross-section.

The melt-spun thermoplastic polyurethane can be spun as single filaments or can be coalesced by conventional techniques into multi-filament yarns. Each filament can be made in a variety of denier. Denier is a term in the art designating the fiber size. Denier is the weight in grams of 9000 meters of fiber. The fibers are preferably at least about 5 denier, and preferably are up to about 2000 denier, more preferably up to about 1200 denier, and most preferably less than 250 denier.

Spinning speeds can be at least about 100 meters per minute (mpm), more preferably at least about 1,000 mpm and can be up to 5,000 mpm or higher.

The fibers can be drawn from about 1.5× to about 8×, preferably at least about 2× and preferably up to about 4×. Single step draw is the preferred drawing technique. In most cases it is preferred not to draw fibers.

The fibers can be heat set, and preferably the heat setting temperature is at least about 100° C. and preferably up to about 175° C.

Finishes can be applied to the fibers for spinning or subsequent processing, and include silicone oil, mineral oil and other spin finishes used for polyesters, spandex elastomers, etc.

The fibers are stretchable, have good chlorine resistance, can be dyed under normal polyester dyeing conditions, and have excellent physical properties, including superior strength and stretch recovery properties, particularly stress decay.

To reduce tackiness certain additives can be introduced into the fibers. These additives include silicon oil, metal stearates such as calcium stearate, sodium stearate, magnesium stearate, talc and barium sulfate and the like. In addition, various finishes have been suggested for lubricating the surfaces of the fibers and thus reducing their tackiness. The fibers thus produced can be processed further, for example, wet dyeing at about 100° C.

Melt-spun fibers using the polyurethanes have many advantages. For example, no solvent is needed either when making polymer compositions or during the actual spinning process, and therefore the final fibers contain no solvent residuals. As a result, the melt spinning process is free of pollution, has reduced production costs—low energy consumption, simple building requirements and minimal labor requirements. In contrast, the solution dry spinning process is very expensive and complicated and requires solvent during polymerization and spinning processes. Solvent must be recovered which means that the installation and operation costs are high. Furthermore, the major ingredient of the polyurethane composition is polytrimethylene ether glycol, which can be prepared from bio-based diol (i.e., 1-3-propanediol prepared by fermentation from carbohydrate (e.g., sugar)) and thus the melt-spun polyurethanes are “greener” than conventional polyurethanes.

Another embodiment is a film comprising the thermoplastic polyurethane. Preferably the thickness of the film is from about 5 μm to 500 μm. The thermoplastic polyurethane films are useful as water vapor permeable materials, particularly those where high breathability to water vapor is vital. Water vapor permeable membranes are useful for many purposes, such as for wound dressings, burn dressings, surgical drapes, and surgical sutures. Preferably the polyurethane membrane has a water vapor permeability rate of at least about 2500 mil-gm/m²/day, more preferably about 2,500 to about 10,000, and most preferably about 3,000 to about 6,000. Water vapor permeability is measured according to ASTM F1249. The WVTR is calculated by measuring how many grams of water in vapor form go through one square meter of film in 24 hours (h) and expressed in units of gm/(m²-24 h). The WVTR of the film is primarily dependent upon its chemical composition and thickness

Another embodiment is a water impermeable, water vapor permeable fabric comprising a variety of substrates including natural or synthetic wovens or non-wovens (e.g., polyester, polyamide, cotton, wool, etc.). The polyurethane films can be laminated on a substrate with adhesives or by bonding directly.

Films can be made by melt-extrusion, blowing, extrusion casting, solution casting, or by calendering, preferably by extrusion casting. To cast the films from solution, the polymer should be dissolved in an appropriate solvent such as dimethylformamide, dimethylacetamide, and tetrahydrofuran. The resulting solution is casted onto a support according to conventional procedure to obtain films upon evaporation of the solvent. When melt-extruded to form films, the polymer is dried first and extruded in an ordinary commercial twin-screw extruder to melt the resin and make the melt homogeneous. The polymer melt is pumped through a filter media with a fine mesh (for example, 70μ filter mesh) to permit further processing. The polymer is then extruded through a conventional “coat hanger” style cast film die. The polymer is cast on a conventional cold quench roll (e.g., water-cooled spiral channels) at temperatures of from about 15 to about 25° C. The properties of the films thus made are tested.

The polyurethane films or fabrics that are breathable to water vapor can be used in healthcare, construction, agriculture and food packaging industries, such as the type described in U.S. Pat. No. 5,120,813. The films are useful wherever water impermeability and water vapor permeability are desired, for example as rainwear or shoe tops uses. The polyurethane films have surprisingly low water absorption, excellent mechanical, elastic and breathable properties, and thus are ideally suitable where dimensional stability is an issue. The films are non-porous membranes.

In addition, the water vapor transmission rate of the films can be enhanced further by making polyurethane films from the blends of polytrimethylene ether glycol and polyethylene glycol. Inorganic salts such as lithium bromide can be added to enhance the moisture vapor transmission rates.

The following examples are presented for the purpose of illustrating the invention, and are not intended to be limiting. All parts, percentages, etc., are by weight unless otherwise indicated.

Trademarks are indicated in all-capital letters, unless otherwise designated.

### EXAMPLES

The 1,3-propanediol utilized in the examples was prepared by biological methods described in U.S. Patent Application Publication No. 2005/0069997, and had a purity of >99.8%.

Test Methods

Number-average molecular weights (Mₙ) of polytrimethylene ether glycol were calculated from the hydroxyl number, which was determined according to ASTM E222 method. Number-average molecular weight and weight-average molecular weight of polyurethane polymers were measured by gel permeation chromatography (GPC).

Melting Point (Tₘ), Crystallization Temperature (Tc) and glass transition temperature (Tg) were determined using the procedure of the American Society for Testing Materials ASTM D-3418 (1988) using a DuPont DSC Instrument Model 2100 (E.I. du Pont de Nemours and Co., Wilmington, Del.). The heating and cooling rates were 10° C. per minute.

Water absorption of polyurethane films is measured according to ASTM D570. The water vapor transmission rate through the films using a modulated infrared sensor was measured according to ASTM F1249 and this method is applicable to films up to 0.1 inch in thickness.

Water vapor permeability was measured according to ASTM F1249.

Fiber Spinning Methods

Melt Spinning Elastic Fiber from a Small Scale Press Spin Unit

To perform the melt spinning, a cylindrical cell of 2.2 cm inside diameter and 12.7 cm length was employed. The cell was equipped with a hydraulically driven ram that was inserted on top of the sample. The ram had a replaceable TEFLON® tip designed to fit snugly inside the cell. An annular electric heater which surrounded the lower quarter of the cell was used for controlling cell temperature. A thermocouple inside the cell heater recorded the cell temperature. Attached to the bottom of the cell was a spinneret, the interior of which included a cylindrical passage, measuring 1.27 cm in diameter with a 0.64 cm cell cavity. The spinneret cavity contained stainless steel filters of the following mesh, inserted in the following order, starting from the bottom (i.e., closest to the exit): 50, 50, 325, 50, 200, 50, 100, 50. A compressible annular aluminum seal was fitted to the top of the “stack” of filters. Below the filters was a cylindrical passage of about 2.5 cm length and 0.16 cm interior diameter, the lower of which was tapered (at an angle of 60 degrees from the vertical) to meet with an outlet orifice measuring 0.069 cm in length and 0.023 cm inside diameter. The spinneret temperature was controlled by a separate annular heater. The exiting filament was wrapped around a set of feed rolls operated at 40 meters/minutes followed by a set of draw rolls operated at 160 meters/minute (4× draw ratio), and then delivered to the final package. The ratio of the speed of the draw roll to the feed roll defines the draw ratio.

The polymer was dried before being transferred to the extruder. Physical properties reported herein are for fibers spun at different draw ratios.

Melt Spinning of Elastic Fiber from a Semi-Industrial Scale Spin Unit (Position a Spinning Machine)

The spinning conditions were as follows. Fibers were melt spun on 28 mM twin screw extruder (Werner & Pfleiderer Corporation, Ramsey, N.J.). The screw speed of the extruder was about 25 rpm. The flow of the polymer melt through the extruder was approximately 13 g/min. A spinneret with 13 holes having dimensions 0.009×0.012 inches was used. A filter having 25/50 mesh was placed before the spinneret. To avoid sticking of the fibers, a finish was spread on the fibers through a syringe pump at the rate of 0.2 ml/min. The spinning was done at a spinning temperature of 230° C., and the fiber was wound at winding speeds ranging from 750 to 1000 mpm.

### Fiber Properties

### Fiber Tenacity and Elongation

Tenacity at break, T, in grams per denier (gpd) and percent elongation at break, E, were measured on an Instron® Tester equipped with a Series 2712 (002) Pneumatic Action Grips equipped with acrylic contact faces. The test was repeated three times and then the average of the results is reported.

The average denier for the fibers used in the tenacity and elongation measurements is reported as Den 1.

### Fiber Unload Power, Stress Decay and Percent Set

The average denier for the fibers used in measuring unload power, stress decay and percent set is reported as Den 2.

Unload power (TM1) was measured in gram per denier. One filament, a 2 inch (5 cm) gauge length, was used for each determination. Separate measurements were made using zero-to-300% elongation cycles. Unload power (i.e., the stress at a particular elongation) was measured after the samples have been cycled five times at a constant elongation rate of 1000% per minute and then held at 100% or 300% extension for half a minute after the fifth extension. While unloading from this last extension, the stress, or unload power, was measured at various elongations.

Stress Decay was measured as the percent loss of stress on a fiber over a 30 second period with the sample held at 100 or 300% extension at the end of the fifth load cycle.

S=((F−C)*100)/F

where:

S=Stress Decay, %

F=Stress at full extension

C=Stress after 30 seconds

The percent set was measured from the stress/strain curve recorded on chart paper.

### Example 1

This example illustrates the preparation of a diisocyanate-terminated polytrimethylene ether-urethane prepolymer.

The prepolymer was prepared as follows. Polytrimethylene ether glycol (2.885 kg; 1.44 moles) of number average molecular weight 2,000 was dried to a moisture content less than 500 ppm and then charged to a 5-L four-necked flask equipped with a mechanical stirrer, addition funnel, thermocouple, and a gas inlet adapter. IRGANOX 1098 antioxidant (2.3 g) (Ciba Specialty Chemicals, Tarrytown, N.Y.) was added to the glycol and allowed to mix completely. The mixture was then heated to 60° C. under an inert nitrogen atmosphere. Molten (50° C.) 4,4′-diphenyl methane diisocyanate (ISONATE 125M, Dow Chemical Company, Midland, Mich.) (1.665 kg; 6.66 mol) was added slowly to the mixture at a rate sufficient to maintain a reaction temperature of <70° C. The reactor temperature was held at 70° to about 80° C. until the NCO:OH reaction was complete. The final % NCO content in the prepolymer is 9.6%. The prepolymer product was degassed and transferred hot to a clean dry plastic container and sealed under a nitrogen atmosphere until tested or used.

### Comparative Example A

This example is a control example illustrating preparation of polyurethane utilizing the prepolymer prepared in Example 1 and a diol chain extender, but no monofunctional isocyanate reactive compound.

An aliquot (800 g) of diisocyanate-terminated polytrimethylene ether-urethane prepolymer made in Example 1 was transferred to another reactor and held at 60° C. Preheated 1,4-butanediol (78 g; 0.865 mol) was added to the prepolymer and mixing was continued for about 90 seconds, until the diol was visually mixed into the prepolymer. The reaction mixture was then poured into an open-faced mold and placed into an oven for post cure at 110° C. for 16 hours. The NCO/OH ratio in the polymer is 1.05:1.

### Example 2

This example illustrates preparation of a diisocyanate-terminated polytrimethylene ether-urethane prepolymer for use in subsequent reaction with chain extender and monofunctional isocyanate reactive compound.

Polytrimethylene ether glycol (937.1 g; 0.4685 mol) of molecular weight 2,000 was dried and then charged to a 2 liter four necked flask equipped with a mechanical stirrer, addition funnel, thermocouple, and a gas inlet adapter. Antioxidant (blend of IRGANOX 1076 and ETHANOX 300 (2.3 g)) was added to the polyol and allowed to mix completely. This mixture was then heated to 60° C. under an inert nitrogen atmosphere. Molten (50° C.) 4,4-diphenyl methane diisocyanate (541 g of ISONATE 125M) was added slowly to the mixture at a rate sufficient to maintain a reaction temperature of <70° C. The reactor was held at 70 to 80° C. until the NCO:OH reaction was complete. The prepolymer product was degassed and transferred hot to a clean dry plastic container and sealed under a nitrogen atmosphere for later use.

### Example 3

This example illustrates preparation of a polyurethane by reaction of the prepolymer prepared in Example 2 with 1,4-butanediol diol chain extender, and n-butanol.

An aliquot (273 g) of diisocyanate-terminated polytrimethylene ether-urethane prepolymer from Example 2, having a % NCO content of 9.68%, was transferred to another reactor and kept at 60° C. A preheated mixture of 1,4-butanediol (27.5 g; 0.305 moles) and n-butanol (0.34 g; 0.0045 moles) were added to the prepolymer. Mixing was continued for about 90 seconds, until the diol was visually mixed into the prepolymer. The reaction mixture was poured into an open-faced mold and placed into an oven for post-cure at 110° C. for 16 hours. The NCO/OH ratio in the polymer is 1.026:1.

### Example 4

This example illustrates preparation of a polyurethane by reaction of the prepolymer prepared in Example 2 with 1,4-butanediol diol chain extender, and n-butanol. In this example the level of n-butanol was higher than that in Example 3 to illustrate that the product compositions were extrudable at both levels.

An aliquot (365 g) of diisocyanate-terminated polytrimethylene ether-urethane prepolymer prepared in Example 2 was transferred to another reactor and held at 60° C. A preheated mixture of 1,4-butanediol (36.6 g; 0.406 mol) and n-butanol (0.9 g; 0.012 mol) were added to the prepolymer. Mixing was continued for about 90 seconds, until the diol was visually mixed into the prepolymer. The reaction mixture was poured into an open-faced mold and placed into an oven for post-cure at 110° C. for 16 hours. The NCO/OH ratio in the polymer is 1.022:1.

### Example 5

This example illustrates preparation of a polyurethane from polytrimethylene ether glycol, 4,4′-diphenyl methane diisocyanate, a mixture of 1,4-butanediol and of 1,3-propanediol chain extenders where 1,4-butanediol was the primary chain extender, and n-butanol.

Polytrimethylene ether glycol (2.1 kg; 0.868 mol) of molecular weight 2,420 was dried and then charged to a 5-L four-necked flask equipped with a mechanical stirrer, addition funnel, thermocouple, and a gas inlet adapter. An antioxidant blend of IRGANOX 1076 and ETHANOX 300 (4.8 g) was added to the polyol and allowed to mix completely. This mixture was then heated to 60° C. under an inert nitrogen atmosphere, and then 900 g (3.6 mol) of molten (50° C.) 4,4′-diphenyl methane diisocyanate was added slowly to the mixture at a rate sufficient to maintain a reaction temperature of <70° C. The reaction mixture was held at 70° to about 80° C. until the NCO:OH reaction was complete. The prepolymer product had a % NCO content of 7.60.

The entire amount of prepolymer was degassed in vacuum oven at 60° C. for two hours, and then a mixture of 235 g (2.60 mol) of 1,4-butanediol, 2.0 g (0.026 mol) of 1,3-propanediol and 2.94 g (0.0397 mol) of n-butanol was added to the prepolymer in a round bottom flask at 60° C. The resulting reaction mixture was mixed thoroughly for about 90 seconds and then allowed to cure in the round bottom flask and then placed in an oven for post cure at 110° C. for 16 hours. The NCO/OH ratio in the polymer is 1.022:1.

### Example 6

Polytrimethylene ether glycol (2.82 kg) having a number average molecular weight of 2,420 was dried and charged to a 5-L flask equipped with a mechanical stirrer, addition funnel, thermocouple, and gas inlet adapter. LOWINOX 1790 antioxidant (6.14 g) was added and allowed to mix completely. Then the mixture was heated to 60° C. under a nitrogen atmosphere. Methylene diphenyl diisocyanate (981 g) was added slowly to the reactor and allowed to mix for roughly two hours, at which time, a small sample was removed for analysis of NCO functionality present in the prepolymer. Percent NCO was 6.13%. The prepolymer was degassed under vacuum in the round bottom flask for 2 hours, and then a mixture of 242.5 g (2.69 mol) 1,4-butanediol, and 2.93 g (0.0395 mol) n-butanol, preheated to 60 C, was added with stirring. Mixing was continued for 3.5 minutes, until the butanediol mixture was visually mixed into the prepolymer. The resulting mixture was allowed to cure in the flask, and then placed into an oven for post cure at 110° C. for 16 hours. The NCO/OH ratio in the polymer is 1.022:1.

The properties of the polyurethane polymers prepared are listed in Table 1.

### Example 7

This example illustrates the results of melt spinning fibers from the melt polymerized polyurethane compositions described in Examples 3-6 and Comparative Example A. The fibers were spun from the compositions described in Examples 3 and 4 by the press spin unit procedure described above. Fibers were spun from the compositions described in Examples 5 and 6 by the semi-industrial spinning machine.

Attempts to melt spin fibers from the polyurethane prepared in Comparative Example A using press spin unit, containing no monofunctional isocyanate reactive compound, were not adequate due to filament breaks. This demonstrates that the comparative polytrimethylene ether urethanes, which do not contain monofunctional compounds, are not as well suited for melt-spinning and that this deficiency is overcome by the compositions disclosed herein.

Properties of monofilament fibers are presented in Table 2 and of multifilament fibers in Table 3.

TABLE 1
Properties of TPU

| | HS | | | | Tg | Tm | Tc |
|---|---|---|---|---|---|---|---|
| Example | % | NCO:OH | Mn | Mw | ° C. | ° C. | ° C. |
| Comp A | 42 | 1.05:1 | 28650 | 57180 | −62 | 186; 209; | 129 |
| | | | | | | 226 | |
| 3 | 42 | 1.026:1 | 32990 | 59700 | −58 | 180 | 110 |
| 4 | 42 | 1.022:1 | 31040 | 54280 | −59 | 183; 208 | 113 |
| 5 | 35 | 1.022:1 | 33800 | 62740 | −63 | 177; 192; | 113 |
| | | | | | | 211 | |
| 6 | 30 | 1.022:1 | 41740 | 87590 | −62 | 173 | 98 |

Multiple hard segment melt transitions (Tm) over a broad temperature range were observed.

TABLE 2
Melt-spun Elastic Fiber (mono-filament) Properties

| | | Spin | | | | | | Stress | |
|---|---|---|---|---|---|---|---|---|---|
| | Draw | speed | | Tenacity | Elongation | | TM1 | Decay | Set |
| Exp. | Ratio | mpm | Den 1 | (gpd) | (%) | Den 2 | (gpd) | (%) | (%) |
| Comp A | Not melt spinnable | | | | | | | | |
| 3 | 1X | 210 | 31 | 1.19 | 400 | 27 | 0.13 | 27 | 57 |
| | 2X | 160 | 44 | 1.58 | 290 | 46 | 0.20 | 27 | 58 |
| | 4X | 300 | 31 | 2.46 | 190 | 34 | 0.49 | 24 | 67 |
| | 6X | 430 | 31 | 2.17 | 170 | 27 | 0.55 | 20 | 68 |
| 4 | 1X | 210 | 49 | 1.42 | 320 | 49 | 0.17 | 27 | 56 |
| | 2X | 160 | 35 | 2.14 | 200 | 36 | 0.44 | 24 | 66 |
| | 4X | 290 | 31 | 2.35 | 190 | 31 | 0.55 | 22 | 68 |
| | 5X | 360 | 16 | 2.21 | 170 | 14 | 0.66 | 23 | 69 |

Spin temperatures were in the range of 225-230° C. The TM1, stress decay and set measurements were made using zero-to-100% elongation cycles

TABLE 3
Melt-spun Elastic Fiber (multi-filament) Properties

| | | Spin | | | | | | Stress | |
|---|---|---|---|---|---|---|---|---|---|
| | Draw | speed | | Tenacity | Elongation | | TM1 | Decay | Set |
| Ex | Ratio | Mpm | Den 1 | (g/d) | (%) | Den 2 | (g/d) | (%) | (%) |
| 5 | 5X | 1000 | 160 | 0.746 | 300 | 152 | 0.003 | 27 | 55 |
| | 5X | 750 | 232 | 0.713 | 290 | 252 | 0.0045 | 26 | 53 |
| 6 | 2.5X | 1125 | 82 | 0.477 | 313 | 83 | 0.0032 | 25 | 54 |
| | 2.5X | 1500 | 76 | 0.435 | 305 | 67 | 0.0029 | 25 | 57 |

Spin temperature was 230° C. for polymer in Example 5 and 210° C. for polymer in Example 6. A 13 hole 0.009 × 0.012 spinneret was used. The TM1, stress decay and set measurements were made using zero-to-300% elongation cycles.

The above examples demonstrate making melt spun fibers from the polyurethane compositions in an environmentally friendly process without use of solvent and use of bio-based polytrimethylene ether glycol ingredient. The data in Tables 2 and 3 indicate that the fibers, yarns and filaments show a low stress decay or stress relaxation. This behavior is very similar to rubber, and superior to the dry-spun spandex elastomeric fibers. Further optimization of the process will achieve even better properties.

### Example 8

This example illustrates the preparation of polyurethane composition from polytrimethylene ether glycol for films.

934.3 g polytrimethylene ether glycol with a Mn of 1380 was added to a three neck round bottom flask under nitrogen purge. Vacuum was applied to the sample, and the temperature was raised to 105° C. for two hours. The temperature was reduced to 60° C., and 1.6931 g of LOWINOX 1790 antioxidant (Great Lakes Chemicals, West Lafayette, Ind.) was added to the polyol and allowed to fully mix in. 505.2 g (2.02 mol) of ISONATE 125M was added to the polyol and the reactor temperature raised to 80° C. The sample was reacted until the NCO content was measured at 7.85%. 117.5 g (1.30 mol) of 1,4-butanediol, mixed with 1.4677 g (0.02 mol) of n-butanol, was added to the prepolymer, and allowed to react until fully polymerized. The polymerized sample was placed into a 110° C. oven and heated for 16 hours.

### Comparative Example B

This example illustrates the preparation of polyurethane composition from polytetramethylene ether glycol.

981.8 g TERATHANE 1000 (polytetramethylene ether glycol) was added to a three neck round bottom flask under nitrogen purge. Vacuum was applied to the sample, and the temperature raised to 105° C. for two hours. The temperature was reduced to 60° C., and 1.8870 g of LOWINOX 1790 was added to the polyol and allowed to fully mix in. 574.6 g of ISONATE 125M was added to the polyol and the reactor temperature raised to 80° C. The sample was reacted until the NCO content was measured at 6.51%. 104.8 g of 1,4-butanediol, mixed with 1.2931 g of n-butanol, was added to the prepolymer, and allowed to react until fully polymerized. The polymerized sample was placed into a 110° C. oven and heated for 16 hours.

### Example 9

This example demonstrates preparation of polyurethane films.

The films were made using a 28 mm extruder (Werner & Pfliederer), equipped with Foremost #11 feeder, #3 casting drum, and #4 winder. The hopper and throat of the extruder had a nitrogen blanket.

Polyurethane crumb was fed through the hopper into the twin screw extruder. The sample was heated to melt and fed into a film die. The aperture of the die was set to roughly 5 mil thickness (1 mil= 1/1000 inches=25.4 microns) and the film was extruded continuously at the approximate rate of 3 feet per minute. The film was then cooled at 29° C. on a casting drum, which was equipped with a cooling water jacket. The cooled film was then wound onto a roll with a winder. The temperatures of the extruder zones and dye are listed in Table 4.

TABLE 4
Process conditions for film making

| | Zone Temperatures (° C.) | | | | | Die |
|---|---|---|---|---|---|---|
| EX | 1 | 2 | 3 | 4 | 5 | (° C.) |
| Comp | 137 | 197 | 211 | 210 | 206 | 196 |
| Ex B | | | | | | |
| Ex 8 | 136 | 199 | 209 | 210 | 210 | 209 |

TABLE 5
Properties of TPU films

| | | Comp | |
|---|---|---|---|
| Property | Test Method | Ex. B | Example 8 |
| Film thickness, mils | | 5.0 | 5.5 |
| Water absorption (24 h), % | ASTM D570 | 1.7 | 3.2 |
| Water Vapor Transmission | ASTM F1249 | 397 | 875 |
| Rate, gm/(m²-day) | | | |
| Water Vapor Permeation | | 1983 | 4834 |
| Rate, mil-gm/(m²-day) | | | |
| Stress at break, ksi | ASTM D882-02 | 3.316 | 3.380 |
| Stress at 10% strain, ksi | | 0.268 | 0.263 |
| Strain at break, % | | 395 | 985 |

It is evident from Table 5 that the polytrimethylene ether glycol based polyurethane film has very good mechanical properties (such as tensile strength, and toughness), outstanding elastic (strain) properties and superior breathability over polytetramethylene glycol based urethanes. The combination of high water vapor permeability rate with excellent mechanical and elastic properties is unique to polytrimethylene ether glycol based urethane films. Textile coatings and wound dressing films require a large water vapor permeation rate for optimum comfort during use.

The foregoing disclosure of embodiments of the invention has been presented for purposes of illustration and description. It is not intended to be exhaustive or to limit the invention to the precise forms disclosed. Many variations and modifications of the embodiments described herein will be obvious to one of ordinary skill in the art in light of the disclosure.

What is claimed is:

1. A thermoplastic polyurethane prepared from reactants comprising:
(a) polytrimethylene ether glycol;
(b) diisocyanate;
(c) diol chain extender; and
(d) monofunctional isocyanate reactive compound
wherein the polytrimethylene ether glycol, the diol chain extender and the monofunctional isocyanate reactive compound contain isocyanate reactive groups; such that the polyurethane contains isocyanate groups in a ratio of about 1.01:1 to about 1.05:1 to the total isocyanate reactive groups contained in the polytrimethylene ether glycol, diol chain extenders and monofunctional isocyanate reactive compound.

2. The thermoplastic polyurethane of claim 1 wherein the monofunctional isocyanate reactive compound is a monofunctional alcohol selected from the group consisting of: n-butanol, n-hexanol, n-octanol, n-decanol, n-dodecanol and mixtures of two or more thereof.

3. The thermoplastic polyurethane-urea of claim 1 wherein the monofunctional isocyanate reactive compound is a monofunctional amine selected from the group consisting of ethyl amine, propylamine, butyl amine, octyl amine, stearyl amine and mixtures of two or more thereof.

4. The thermoplastic polyurethane of claim 1 wherein the monofunctional isocyanate reactive compound is selected from the group consisting of n-butanol, n-hexanol, n-octanol, n-decanol, n-dodecanol, ethyl amine, propylamine, butyl amine, octyl amine, stearyl amine and mixtures of two or more thereof;
the diol chain extender is selected from the group consisting of ethylene glycol, 1,2-propylene glycol, 1,3-propanediol, 1,4-butanediol, 1,6-hexanediol, diethylene glycol, 2-methyl-1,3-propanediol, 3-methyl-1,5-pentanediol, 2,2-dimethyl-1,3-propanediol, 2,2,4-trimethyl-1,5-pentanediol, 2-methyl-2-ethyl-1,3-propanediol, 1,4-bis(hydroxyethoxy)benzene, bis(hydroxyethylene)terephthalate, hydroquinone bis(2-hydroxyethyl)ether, and mixtures of two or more thereof; and
the diisocyanate is selected from the group consisting of 2,4-toluene diisocyanate, 2,6-toluene diisocyanate, 4,4′-diphenylmethane diisocyanate, 4,4′-dicyclohexylmethane diisocyanate, 3,3′-dimethyl-4,4′-biphenyl diisocyanate, 1,4-benzene diisocyanate, cyclohexane-1,4-diisocyanate, 1,5-naphthalene diisocyanate, 1,6-hexamethylene diisocyanate, 4,6-xylyene diisocyanate, isophorone diisocyanate, and mixtures of two or more thereof.

5. The thermoplastic polyurethane of claim 1 wherein the polytrimethylene ether glycol is blended with up to about 50 wt. % of other polymeric glycols selected from the group consisting of hydroxyl terminated polyether glycols, polyester glycols, polycarbonate glycols and silicone glycols.

6. The thermoplastic polyurethane of claim 1 wherein the polytrimethylene ether glycol is not blended with other polymeric glycols.

7. The thermoplastic polyurethane of claim 5, wherein the other polymeric glycols are polyether glycols selected from the group consisting of: homo and copolyethers of polyethylene glycol, poly(1,2-propylene glycol), polytetramethylene ether glycol, and mixtures of two or more thereof.

8. The thermoplastic polyurethane of claim 1 wherein the polytrimethylene ether glycol comprises repeat units, of which about 75 to 100 mole percent of the repeat units of are trimethylene ether units.

9. A thermoplastic polyurethane comprising:
(a) 80 to 20 weight % of the thermoplastic polyurethane, soft segment derived from polytrimethylene ether glycol;
(b) 20 to 80 weight % of the thermoplastic polyurethane, hard segment derived from diisocyanate and diol; and
(c) 1 to 5 mole %, with respect to the diol, of a, monofunctional isocyanate reactive compound, alcohol or amine processing aid;
wherein the diisocyanate contains isocyanate groups in a ratio to total hydroxyl and amine groups contained in the polytrimethylene ether glycol, diol chain extenders and monofunctional alcohol or amine of from about 1.01:1 to about 1.05:1.

10. A shaped article comprising the thermoplastic polyurethane of claim 1.

11. The shaped article of claim 10 selected from the group consisting of fibers, films, sheets, hoses, tubing, wire and cable jackets, shoe soles, air bag bladders, woven fabrics, knit fabrics, and water vapor permeable membranes.

12. A melt spun fiber comprising the thermoplastic polyurethane of claim 1.

13. A process for producing a thermoplastic polyurethane comprising:
(a) reacting diisocyanate and polytrimethylene ether glycol to form diisocyanate-terminated polytrimethylene ether-urethane prepolymer at a temperature in the range from 50 to 100° C.;
(b) reacting the diisocyanate-terminated polytrimethylene ether-urethane prepolymer with diol chain extender and monofunctional alcohol or amine, to form a reaction mixture; and
(c) post curing the reaction mixture at 110° C. for 16 hours;
such that the polyurethane contains isocyanate groups in a ratio to total hydroxyl and amine groups contained in the polytrimethylene ether glycol, diol chain extenders and monofunctional alcohol or amine of about 1.01:1 to about 1.05:1.

14. The process of claim 13 wherein the reacting the diisocyanate and polytrimethylene ether glycol to form the polytrimethylene ether-urethane prepolymer is carried out while maintaining an NCO:OH equivalent ratio in the prepolymer of about 1.1:1 to about 10:1.

15. A process for producing thermoplastic polyurethane comprising:
(a) providing (i) diisocyanate, (ii) polytrimethylene ether glycol, (iii) diol chain extender; and (iv) monofunctional alcohol or amine; and
(b) reacting the diisocyanate, the polytrimethylene ether glycol, the diol chain extender and the monofunctional alcohol or amine in an extruder at a temperature of from about 100° C. to about 250° C. to form the polyurethane, such that the polyurethane contains isocyanate groups in a ratio to total hydroxyl and amine groups contained in the polytrimethylene ether glycol, diol chain extenders and monofunctional alcohol or amine of about 1.01:1 to about 1.05:1.
